(19) United States
(12) Patent Application Publication
(10) Pub. No.: US 2001/0025299 A1
(43) Pub. Date: Sep. 27, 2001

(54) Rule-mitigated collaboration system and method

(76) Inventors: Carl Chang, Chicago, IL (US); Francis Quek, Beavercreek, OH (US)

Correspondence Address: JoAnne Redmann, Crosby, Heafey, Roach & May, Suite 700, 1901 Avenue of the Stars, Los Angles, CA, 90067, US

(21) Appl. No.: 09/752,135

(22) Filed: Dec. 19, 2000

Related U.S. Application Data
(60) Provisional application No. 60/174,154, filed on Jan. 3, 2000.

(51) Int. Cl. G06F 15/16

(52) U.S. Cl. 709/204

(57) ABSTRACT

The present invention provides for an electronic meeting system and method which facilitates the scheduling and operation of electronic meetings. The present invention also provides for the generation of co-authored artifacts, such as documents, designs, project plans, and the like, which are the direct outcome of the collaborative process via the Internet. In order to more effectively host formal meetings, modified rules of order are implicated based on Robert's Rules of Order in a preferred embodiment. Electronic collaboration can take place in concurrent or non-concurrent time frames, and in centralized or distributed locations, rendering this invention invaluable in the modern field of communication.

### BACKGROUND OF THE INVENTION

1. Area of the Art

Given the growing use of computers, telecommunication devices and the Internet, large number of individuals and companies are meeting and collaborating electronically. Electronic collaborating results in the obvious benefits of saved time and reduced expense as compared with traditional meetings where physical presence is a requirement. The present invention relates to a system and method that provide the ability to collaborate electronically, such as via the Internet. In addition to the benefits above, electronic collaborating is more flexible in that meetings can take place in real time, or non-concurrently depending on the needs involved. The present invention also accommodates formal meetings, something not found in the prior art, where rules of order, designed specifically for Web-based use, are implemented.

2. Description of the Prior Art

Even though many aspects of informal meetings have been studied, there exists no known published research that explores computer-based formal meetings. In real life, however, the importance of formal meetings is very obvious. Without formal meetings, differing ideas cannot be shared in an open and facilitative environment thereby rendering the outcome, that is, the decision, irresolute.

Formal meetings are those meetings which proceed with rules of order. Such rules allow everyone to be heard and to make decisions without confusion. Formal meeting rules ensure the right of the majority, protect the rights of the minority, confine debate to the merits of the question under discussion and make the meeting run efficiently, clearly and fairly.

An important aspect of collaborative systems is that of so called co-authoring systems. Given that the procedure and substance of formal meetings are often memorialized in written form, co-authoring systems allow multiple participants to edit, revise or amend a single document. Co-authoring systems may be divided into two categories: synchronous co-authoring systems and asynchronous co-authoring systems. Examples of synchronous co-authoring systems, which allow users to work on a same document at the same time include DistEdit, SASE, and Shared Books. Examples of asynchronous co-authoring systems which allow multiple users to edit a document at different times include Quilt and PREP. Two other systems, IRIS and Lotus Notes, support both asynchronous and synchronous collaborations.

Each environment introduced above, however, has disadvantages. Lotus Notes is not designed to be a co-authoring tool; rather, it is used in a write-review-comment environment. DistEdit, SASE and Shared Books allow users to use their favorite editors, but it requires those editors to be modified. PREP and Quilt are based on the writing, reviewing, and commenting process. However, they do not allow equal access to the document for all users because they define the roles of authors as writers and reviewers. IRIS is a multi-user editing environment that allows the integration of specifically designed applications for IRIS and supports both synchronous and asynchronous editing. Nonetheless, IRIS is not easily extendible to integrate other applications without changing IRIS itself.

The invention disclosed is a needed improvement over the prior art. First and foremost, the present invention is designed, in part, as a co-authoring system. Next, it permits general asynchronous distributed (different time, different place) operation and synchronous distributed (different place, same time) operation with implementation of rules of order. Finally, the present invention is designed to easily integrate with outside software applications rendering it unique in the art.

### SUMMARY OF THE INVENTION

Electronic meeting systems manage time and communicative resources, maintain logs, and produce artifacts that constitute the fruit of the collaboration. The present invention facilitates the generation of co-authored artifacts (documents, designs, project plans, etc.) as the direct outcome of a formal collaborative process. The efficacy of rule-mitigated collaboration technology of the present invention is based on four major components: (1) an extended parliamentary procedure rule set, (2) a scoping policy and set of application programming interfaces, (3) an object-based client-server architecture, and (4) an asynchronous meeting environment.

The design of an appropriate paradigm for collaboration ultimately stands or falls on the question of whether human users are able to cooperate effectively with it. Three key process-related challenges have to be considered: communication, coordination, and collaboration. The present invention utilizes rule-mitigated collaboration to address these challenges, implementing appropriate rules of order within a consistent cogent framework. This is facilitated by an object-oriented client-server architecture that provides services and interaction components.

The rules of order in a preferred embodiment of the present invention are adapted from Robert's Rules of Order (“RRO”). RRO are designed to help control meetings of various types. These rules, known also as Parliamentary Procedures, have been tested by time and proved to be an efficient and reliable mechanism for meeting control. Capturing essential features of human interaction, these rules give a solid framework for building logically complete model for computer-supported collaboration system.

By adapting RRO, the present invention leverages the familiar and proven to produce a collaboration environment that exploits the power of modern computing and networking. Since collaborative groups co-author textual, graphical and numerical documents with multiple simultaneous modifications to each document, the present invention is designed to be application independent, having the ability to maintain multiple disparate versions of each document. This is accomplished by exploiting the inherently recursive nature of the amendment-decision cycle, and defining a set of application program interfaces (APIs) that implement a “scoping strategy”.

The present invention also introduces the concept of “motions” to web-based global collaborating systems. Most of meeting related activity takes the form of motions. Motions are categorized into four classes: main motions, subsidiary motions, accidental motions and privileged motions. The present invention can accommodate and process each of these motions in order to facilitate and focus collaboration. Another important element of this meeting model is the concept of the floor. In traditional meetings, the floor is a communication channel that is shared by the members of the assembly and is used for controlled interactions. One obvious limitation of the traditional RRO is the requirement of the unique floor. This limitation is eliminated in the electronic collaboration of the present invention which takes advantage of the capacity of electronic networks to handle multiple simultaneous communication channels.

Since RRO are designed to regulate formal collaboration on a single communication channel, and account for limitations of human short-term memory and attention, impediments on the flow of the meeting occurred. These impediments are ameliorated, or eliminated entirely, given the ability for multi-level communication offered by the present invention. Furthermore, some of the impediments are relaxed by employing a user interface. One essential purpose of RRO is to regulate and/or limit behavior. This results in restriction of amendment nesting on a single level which creates difficulty for members of an assembly to track multiple levels of detail and complexity. Such difficulty is lessened by the user interface design of the present invention. By generating running minutes of a meeting and producing an explicit tree-like structure of the meeting, the present invention allows the users to track the course of a meeting at any given time.

Since traditional meetings are centralized, that is, they require the physical presence of assembly through the course of a meeting, RRO provide for physical interruptions such as “breaks” and “recesses”. There is no need for such interruption in the present invention which provides distributed meetings which participants attend from remote locations. Further, the present invention also allows for asynchronous distributed electronic meetings, which allows non-simultaneous participation. In asynchronous meetings provided by the present invention, the motion to “recess” can be abolished altogether. The electronic meeting is adjourned only when the collaboration group reaches the point of logical conclusion of the intended project.

Also, in traditional meetings an agenda for a meeting must be fixed prior to the meeting and cannot be changed. Each meeting must follow its agenda and questions outside the agenda are not considered. This rule of immutability of the agenda proves too restrictive for a persistent meeting environment that may continue for weeks and months. Over time, the relevance and efficacy of any agenda will eventually become outdated. The present invention provides a mechanism by which the agenda may be modified dynamically during the collaboration process.

A traditional meeting has a single physical floor and consists of a thread of proposals, amendments, discussions and decisions. A discussion thread is very much like an execution thread in a multi-threaded computer program. A thread may be nested one level deep when amendments are considered. This concept is extended to that of a general discussion thread to represent a single semantically cogent path through the ‘meeting space’. A key requirement of such threads is that it must be relatively independent of each other.

Formally, a discussion thread is defined as an independent execution context for meeting-related action, and it is used to organize cooperative activity into logically related clusters with well-defined boundaries. Threads may further be organized into parent-child hierarchies. This parent-child thread relationship is particularly helpful for dealing with adoption of traditional RRO to electronic collaboration, vis a vis multiple amendment nesting. A meeting is a collection of concurrently running discussion threads, each with its own objective. All threads are coordinated by a main thread with their parent threads using synchronization mechanisms yet to be established. Given the concurrency of discussion threads, synchronization mechanisms are embedded directly into the extended RRO definition. The present invention incorporates discussion threads to embody such meeting-related action. Synchronization mechanisms link the discussion thread directly to the meeting semantics prescribed by the extended RRO. Hence, there is a one-to-one mapping of motions to discussion threads, and the lifetimes of related motions and discussion threads are simultaneous.

Every meeting has a main discussion thread which represents the whole meeting and serves as a parent to all other discussion threads. This main thread does not have any other goal but to serve as a top-level synchronization-capable container for its children. This main discussion thread has the same life cycle as the meeting. Each subsequent discussion thread has a parent thread and it must coordinate its execution with its parent thread. A parent discussion thread may not terminate while it has non-terminated child discussion threads. This requirement is imposed by the fact that the child thread is nested inside its parent thread just like amendments are nested within proposals.

Parent-child relationships of the discussion threads are useful when dealing with multiple levels of amendment nesting. Having several sibling discussion threads running concurrently in the meeting requires synchronization. Synchronization is required when several discussion threads are initiated concurrently, each dealing with its own agenda item, and, thus, there is an interdependency among them.

Apart from the synchronization function, decision threads delineated by motions and decisions serve to aide the control of flow ensuring that the flow of the collaborative work is goal directed. This implicit synchronization and flow control is augmented by RRO motions that postpone and resumes discussion threads to resolve interdependency deadlocks. Interdependent discussion threads, take place in a persistent meeting environment which may span multiple days, weeks, or even months. During this persistent meeting, the meeting environment is maintained and users may participate in different active discussion threads and review the flow of the meeting by browsing the minutes of the threads.

The present invention functions as a distributed collaborative production environment for multiple applications and media. The outcome of the collaboration is the product, and a cooperative document is one of the central concerns. In order to create consistent, secure, concurrency-control-enabled documents that would be sufficiently generic to serve as a template for representation of a growing variety of different types of documents, the concepts of scope and δ-document (delta-document) is introduced in the present invention.

A δ-document parent is created and embedded with information. Once submitted, a δ-document cannot be deleted or modified unless a decision mechanism is accessed. Each subsequent δ-document is a child to the previous δ-document and is a parent to any subsequent δ-documents. Multiple versions of a δ-document are preserved allowing for simultaneous modification. This is known as “scoping strategy”. Scoping strategy and δ-documents are an extension to the operations applicable to typical documents that will allow sharing of these documents in a disciplined manner. Possible implementation of this extension to the operations may take the form of plug-ins which provide the necessary functionality and may be used to add new types of documents to the distributed collaborative environment.

In the implementation of the present invention, Common Object Request Broker Architecture (“CORBA”) or its equivalent is used as middleware infrastructure. CORBA benefits the present invention as it is one of the dominant standards in the marketplace and is largely system/vendor independent, and therefore allowing for universal utilization of the present invention. This client-server architecture is made up of four major components: Collaboration Server that maintains all the system databases for a particular collaboration group; Collaboration Client that provides user access to the collaboration environment; Collaboration Domain Server that serves as an active directory of collaboration groups in which a user may participate; and Middleware specific components that support interoperation among the other architectural components. In CORBA parlance, this is an “active data bus” that receives object-based messages, locates the appropriate method (object-specific function), and activates the method to respond to the message. It also provides event, time and security invocation services.

The present invention also provides a so called M-Net Synchronous Meeting Environment known as M-Net, an environment useful for instantaneous decision making in time-critical situations. The M-Net environment requires that all participants be simultaneously online. This synchronous system can maximize real-time response and reduce the lag-time inherent to asynchronous meetings. The trade-off is that all participants must be “virtually present”, making meetings more difficult to schedule. Also, since the time dimension is ‘locked’, all members must attend a shared communication stream. Hence, the power of parallel activity by meeting participants in an asynchronous system is sacrificed. Naturally, however, the alternative of holding a traditional meeting requiring physical presence is far more burdensome and expensive than that requiring only virtual presence.

The present invention, augmented with the synchronous electronic meeting environment M-Net, provides the following innovations: an extended parliamentary procedure rule set adapted for network and parallel operation; a scoping policy and set of application programming interfaces; an object-based client-server architecture; object databases of discussion and shared documents that are compatible with the concept of scoping and δ-document update; an architecture for user communications; a replication strategy; an M-Net synchronous meeting environment that permits users to gather in real-time virtual meetings for time and synchronization critical discussion and decision making. Finally, the use of Meeting Declaration Language (MDL) in the present invention allows RRO to be customized for elective collaboration.

The present invention may be better understood by referring to the following Detailed Description, which should be read in conjunction with the accompanying drawings. The Detailed Description of a particular preferred embodiment, described below, is intended to be a particular example, and not a limitation.

### BRIEF DESCRIPTION OF THE FIGURES

The accompanying drawings, which are incorporated in and constitute part of the specification, illustrate presently known preferred embodiments of the present invention, and together with the preceding general description and the following detailed description, explain the principles of the invention.

In such drawings,

FIG. 1 is a main model (prime page).

FIG. 2 is a page hierarchy of the present invention.

FIG. 3 is a CPN model for floor control.

FIG. 4 illustrates the basic order of business.

FIG. 5 is meeting model.

FIG. 6 is a registration model.

FIG. 7 is a proposal-discussion-decision cycle model.

FIG. 8 is a discussion thread model.

FIG. 9 is an adjournment model.

FIG. 10 is a diagram of delta-document operation.

FIG. 11 is a general client-server architecture model of a preferred embodiment of a present invention.

FIG. 12 is a collaborative server architecture model of a preferred embodiment of a present invention.

FIG. 13 is a collaborative client architecture model of a preferred embodiment of a present invention.

FIG. 14 is a database structure and event management architecture model of a preferred embodiment of a present invention.

FIG. 15 is an RRO simulation utilizing M-Net.

### DETAILED DESCRIPTION OF THE INVENTION

Embodiments consistent with the present invention addresses the need for an efficient system and method for providing, controlling and development of electronic formal meetings. The present system and method described herein may be implemented over a variety of platforms. However, for the purposes of setting forth a preferred embodiment, the present invention is described primarily with regard to the Internet.

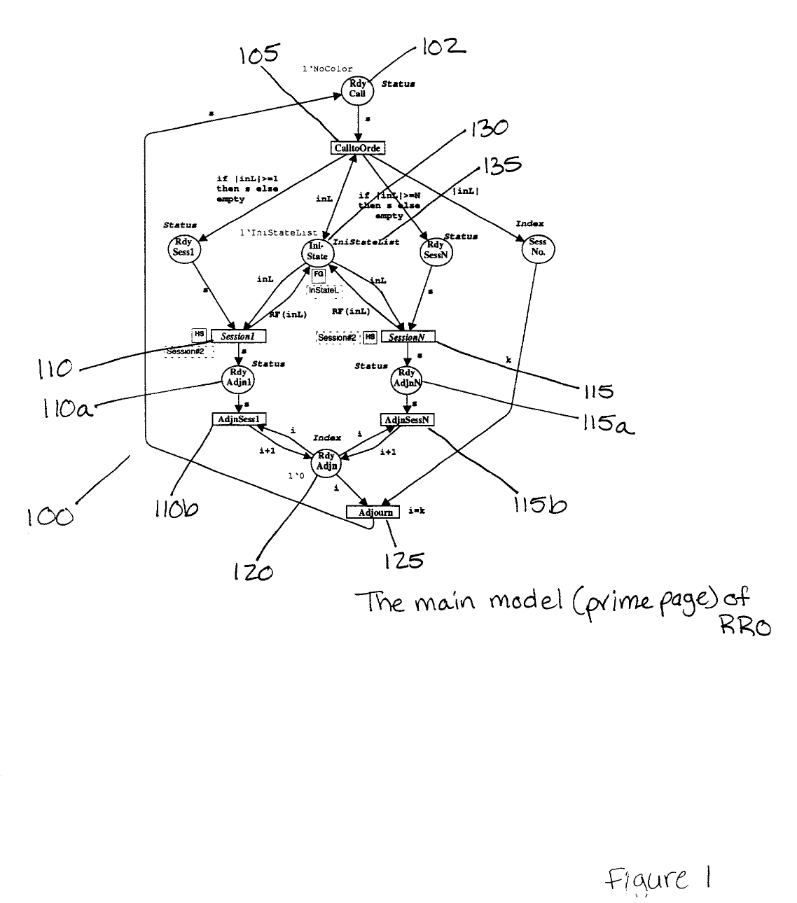

As shown in the exemplary drawings, the present invention is a system and method for providing, controlling and development of electronic formal meetings via the Internet. The neutral state of a preferred embodiment of the present invention is referred to as the Prime Page (100) as shown in FIG. 1. For illustration purposes, two sessions are shown in FIG. 1, Session 1 (110) and Session N (115). Rdy Call (102) signifies that the present invention is poised to call a meeting. CalltoOrdr (105) establishes the calling to order of a meeting; IniState (130) represents the list (135) which includes those participating in the meeting, information pertaining to the number of sessions and some details regarding those sessions. The number of elements in the list (135) determines the number of sessions in meeting.

In a preferred embodiment of the present invention, as each session approaches conclusion, adjournment procedures are engaged. For example, in Session 1 (110), RdyAdjn1 (110a) signifies the commencement of adjournment of that meeting which may represent only one issue of a particular goal. The meeting then progresses to actual adjournment (110b). Similarly, in Session N (115), RdyAdjnN (115a) signifies the commencement of adjournment of that meeting. Session N (115) then progresses to adjournment (115b). Once adjourned, each meeting is given RdyAdjn (120) status which signifies that the issues involved in each adjourned session have been resolved. Once the present invention determines that all pending sessions, in this case Session 1 (110) and Session N (115), are in concluded, the entire series of meetings are Adjourned (125). The present invention will then reset itself to RdyCall (102) status in this preferred embodiment so that it can refine resolutions or entertain new matters.

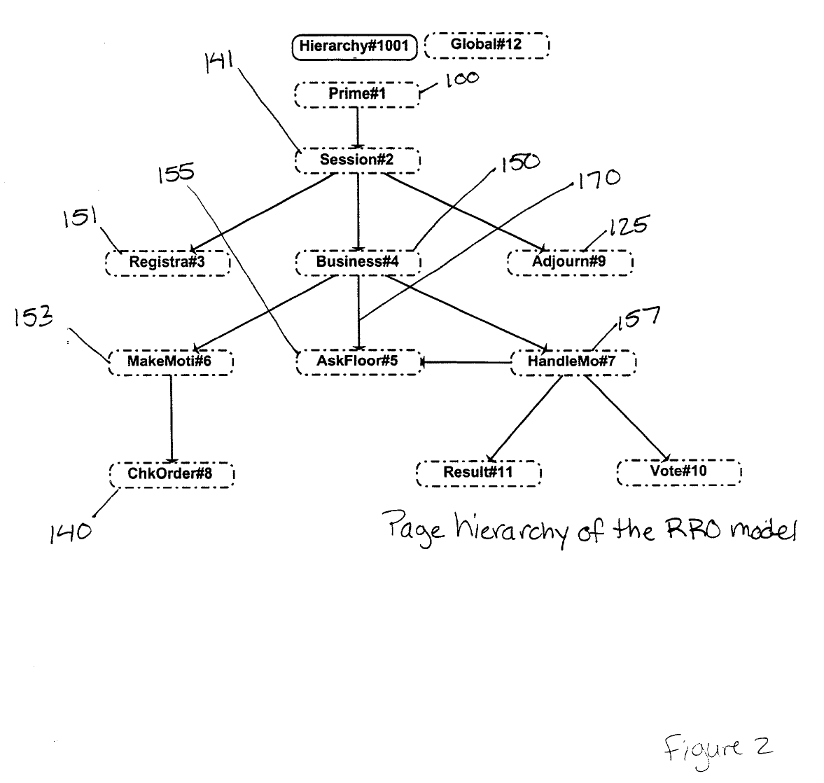

FIG. 2 illustrates the structural architecture of the present invention presented in the form of a page hierarchy (140). In FIG. 2, each node, for example, Business (150) represents a model or submodel referred to as a page (160) or subpage (165), respectively. Each arc (170) drawn between any two given nodes, represents a hierarchal relationship between the two pages or subpages positioned at each end of an arc (170). All subpages (165) can be combined into an integrated page (160) by using the well-defined interfaces (180) between pages (160) and associated subpages (165). In this embodiment, the prime page (100) represents the main model depicted in FIG. 1. The AskFloor Node (155) represents how the floor is controlled in a session, in this case Session#2 (141). Among the various nodes which interact with this process are the following: Adjourn (125), Business (150), Registra (151), MakeMot (153), AskFloor (155), and HandleMot (157).

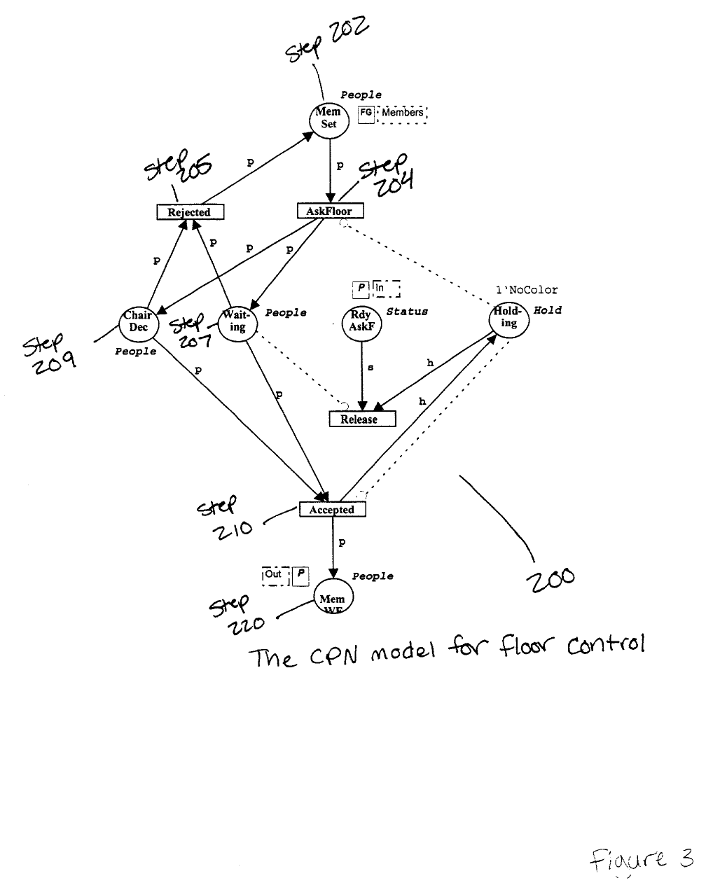

The present invention utilizes the concept of floor motions to establish a floor control model (200) as shown in FIG. 3. Generally, motions are categorized in four classes: main motions, subsidiary motions, accidental motions, privileged motions. Each motion is attached with varying levels of priority. The floor control model (200) is a communication channel that is shared by the members of a meeting and is used for controlled interactions. However, according to standard Robert's Rules of Order (“RRO”), at most one person can be on the floor. Nevertheless, several or all of the participants may request for the floor at the same time. The floor control model (200) of the present invention resolves this problem.

To obtain the floor, a participant must address the chair. In a typical formal meeting, a participant or member sends a request to the chair-client via e-mail or “chat”. If more than one person requests the floor, the chair will decide who is the only person to have the floor according to certain meeting policy. In the present invention, the same procedures are performed over the Web. In the MemSet phase (step 202), the present invention await meeting member requests to process. Once a member requests the floor, the AskFloor phase (step 204) is reached. Depending on the status and protocol of the meeting, the request may be put in the waiting phase (step 207) or moved directly into the ChairDec phase (step 209) where the chair decides on the request. Regardless of whether the request is put in the waiting phase (step 207) or moved directly into the ChairDec phase (step 209), eventually the request will be rejected (step 205) or accepted (step 210). If accepted (step 210), the requesting member will then have the floor (step 220).

In a preferred embodiment of the present invention, RRO are modified and the floor control model (200) is a Colored Petri Net model (“CPN”). RRO used in a Web meeting is concurrent. For example, multiple sessions can run in parallel. Thus CPN has the power to model concurrency. Another important feature of CPN is a “hierarchy” feature which can be used to model complex systems.

This preferred embodiment of the present invention incorporates a means to administer rules of order to an electronic meeting. Color sets and variables are declared in the global declaration node. The color sets in CP-nets are analogous to the data types in programming languages. Moreover, the operations and functions which can be applied to the colors can be defined. Not only are simple color sets defined People and Index, which are a string and an integer respectively, but also Special List and Inistate, which are a list and a record respectively. However, the variables in CP-net model are different from those in programming languages. Even on the same page, the variables with the same name may not be related unless they associate with an identical transition.

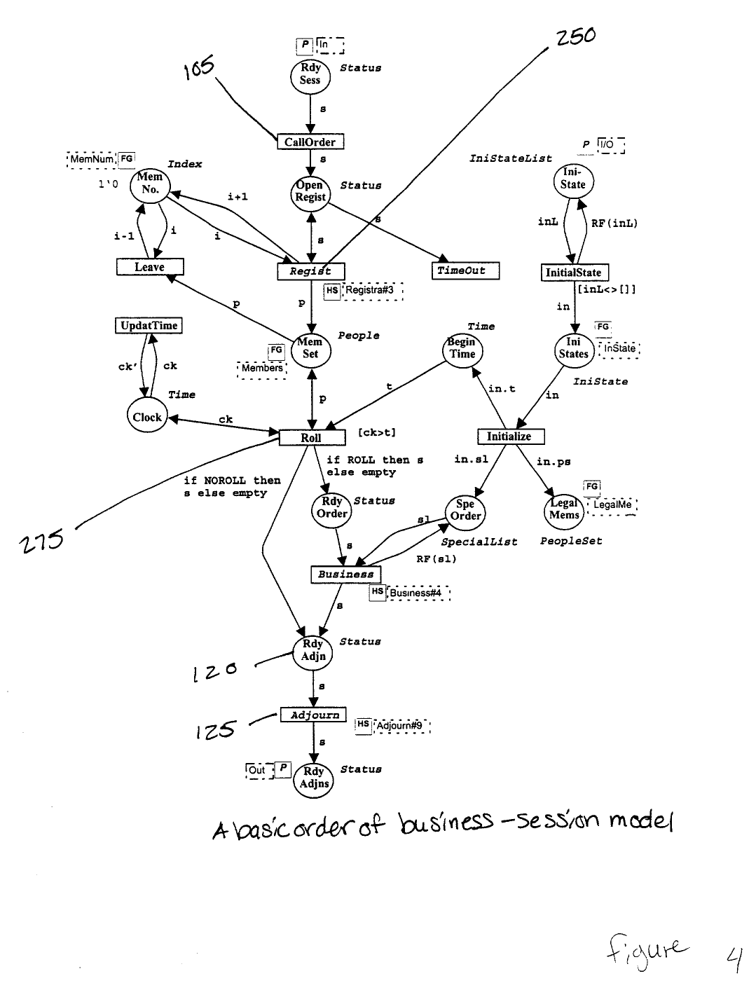

The basic order of business model is illustrated in FIG. 4. Among the components of a meeting are: registration or regist (250), calling a meeting to order or CalltoOrder (105), taking roll or roll (252) and adjournment or adjourn (125). As shown in FIG. 4, registration represents the number of users participating in the meeting. The number of meeting participants or members is established by an initial value. At the time to begin a meeting, the transition is ready to fire and the meeting is ready to begin conducting business. A condition to commencing a meeting is established, such as the requirement of a minimal number of members present (i.e. a quorum). In this scenario, if a quorum is not reached, the meeting adjourns (125). Once the business is in session, more details will be provided in the subpage (165). The number of participants trying to register (250) can be unlimited. However, only participants whose name is in the name set represented by the token can be accepted. The accepted participants (i.e. tokens) will be put into place and the rejected participants will disappear at the transition.

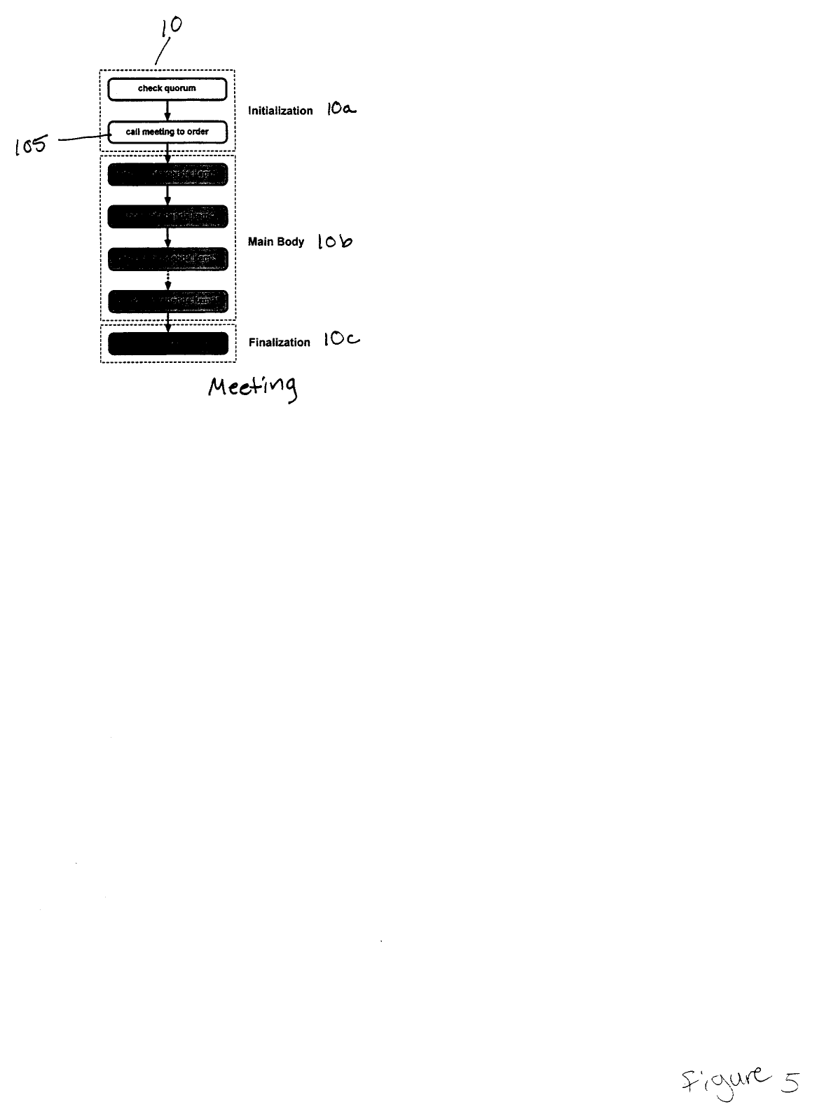

The phases of a meeting are illustrated in FIG. 5. Traditional meetings (10) pass from an initialization phase (10a), to an agenda phase (10b), and finally to a finalization phase (10c) where a decision is rendered. While traditional meetings must have a well-defined purpose or plan that is formalized in the agenda phase (10b), this is not so in the present invention. Because the present invention addresses both synchronous and asynchronous meeting, it is possible to create, establish and refine agendas during the meeting process, as opposed to before. This allows for more flexible collaboration in that agendas are created with the input of all participants rather than just a few.

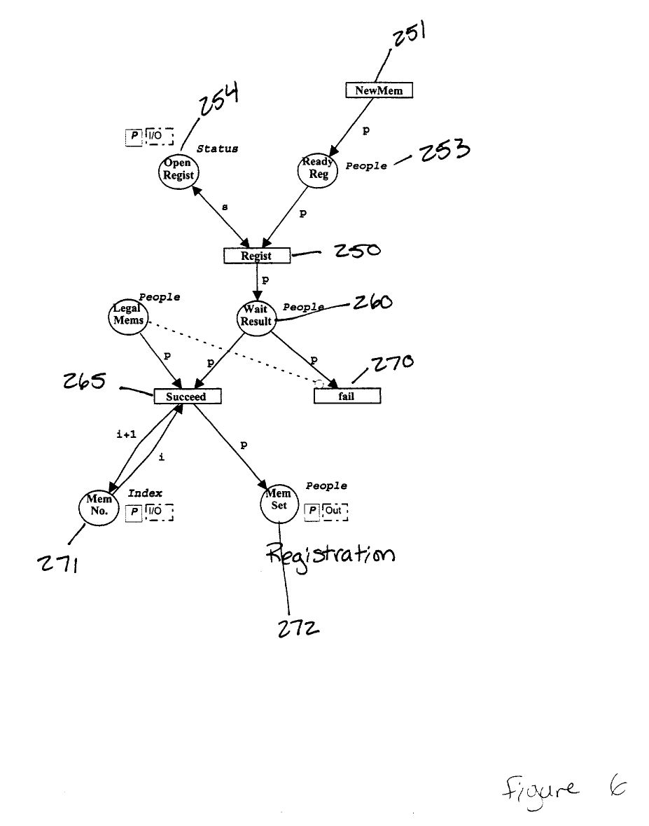

FIG. 6 illustrates the registration process. A resource transition NewMem (251) can register accommodate an unlimited number of new registrants. Registrants may also enter the system if they are already registered, designated as AlreadyReg (253), or by open registration, designated by OpenReg (254). Registrants are then scrutinized by a control (260), and either succeed (265) or fail (270) to be registered. If a registrant succeeds (265), the registrant is assigned a member no. (271) and can participate in any meeting provided for in the member set (272). If the member set (272) is open to all, any registrant can enter the session. The accepted registrants will be put into MemSet (272) and those rejected disappear at the sink transition fail (270).

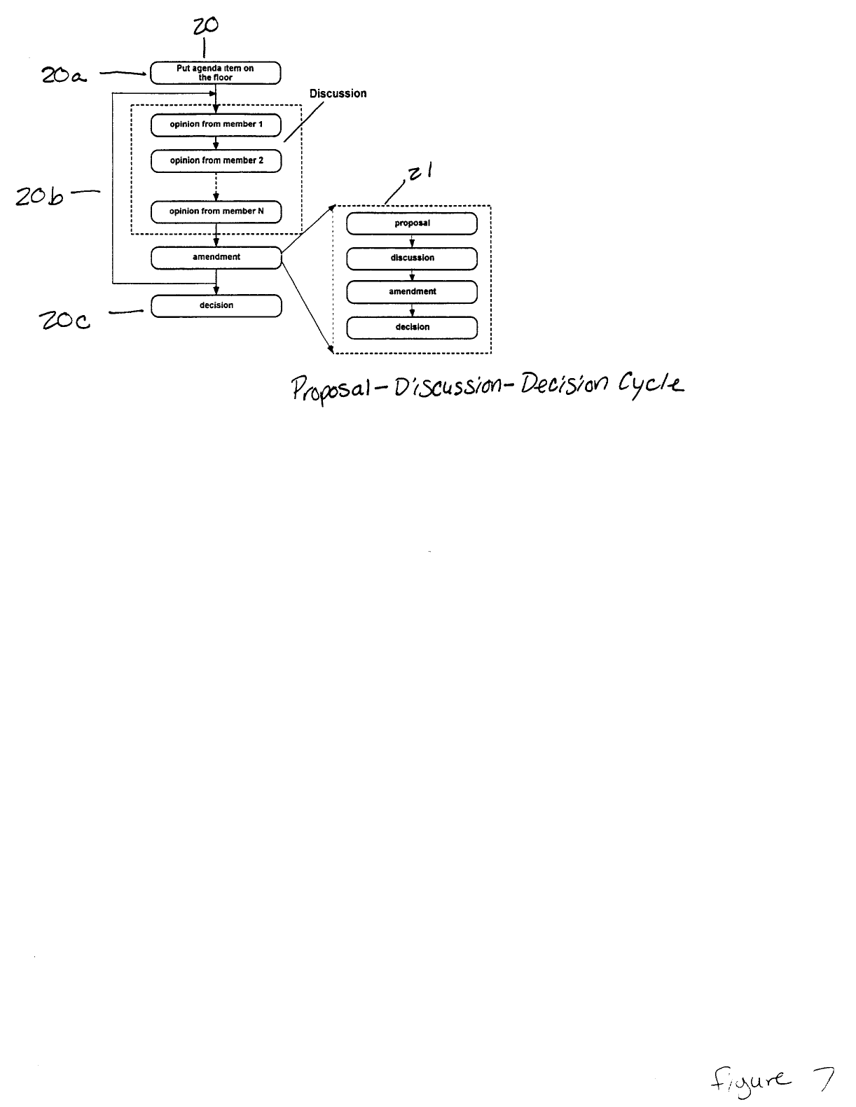

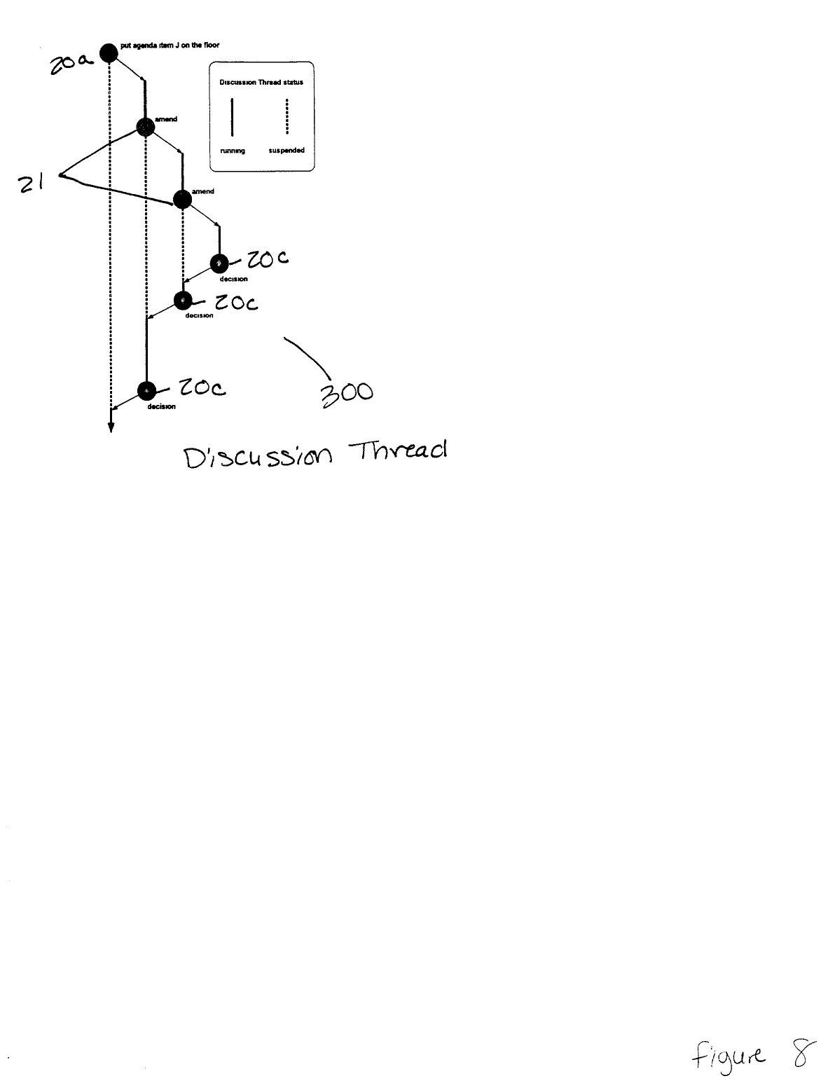

FIG. 7 represents a graphical representation of a proposal-discussion-decision cycle (20). The proposal-discussion-decision cycle (20) consists of three main parts. Namely, the three parts are as follows: proposal (20a), discussion (20b) and decision (20c). The proposal discussion-decision cycle (20) further includes an amendment phase (21) where decisions are refined and perfected. With the present invention, all three parts of the proposal-discussion-decision cycle (20) may be accomplished electronically in either a synchronous or asynchronous manner. The concept of discussion threads (300), which facilitates decisions in a multi-floor situation, is illustrated in FIG. 8. Again the same principles are used commencing with a proposal (20a), execution of amendments (21), resulting in a series of decisions (20c).

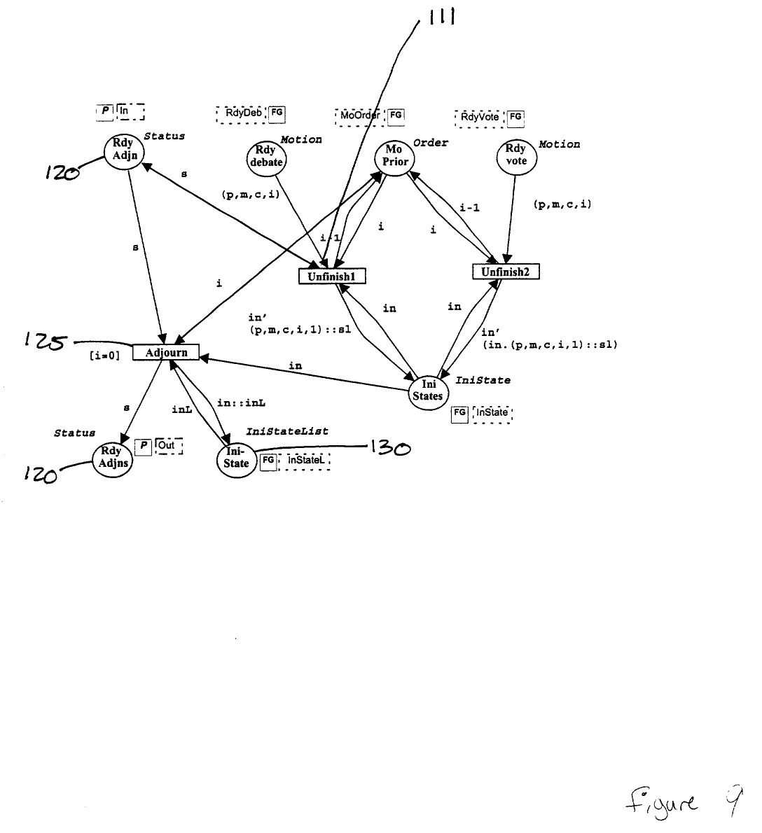

Before the meeting is adjourned, all the unfinished business (111) will be checked as shown in FIG. 9. If there are still sessions pending, reflected by tokens, the associated information will be stored. This is done by firing the transitions. After the transition fires, the meeting session will adjourn (125). As mentioned earlier, when all the sessions in a meeting adjourn (125), the present invention returns back to the initial state (130) and is ready to begin the next meeting.

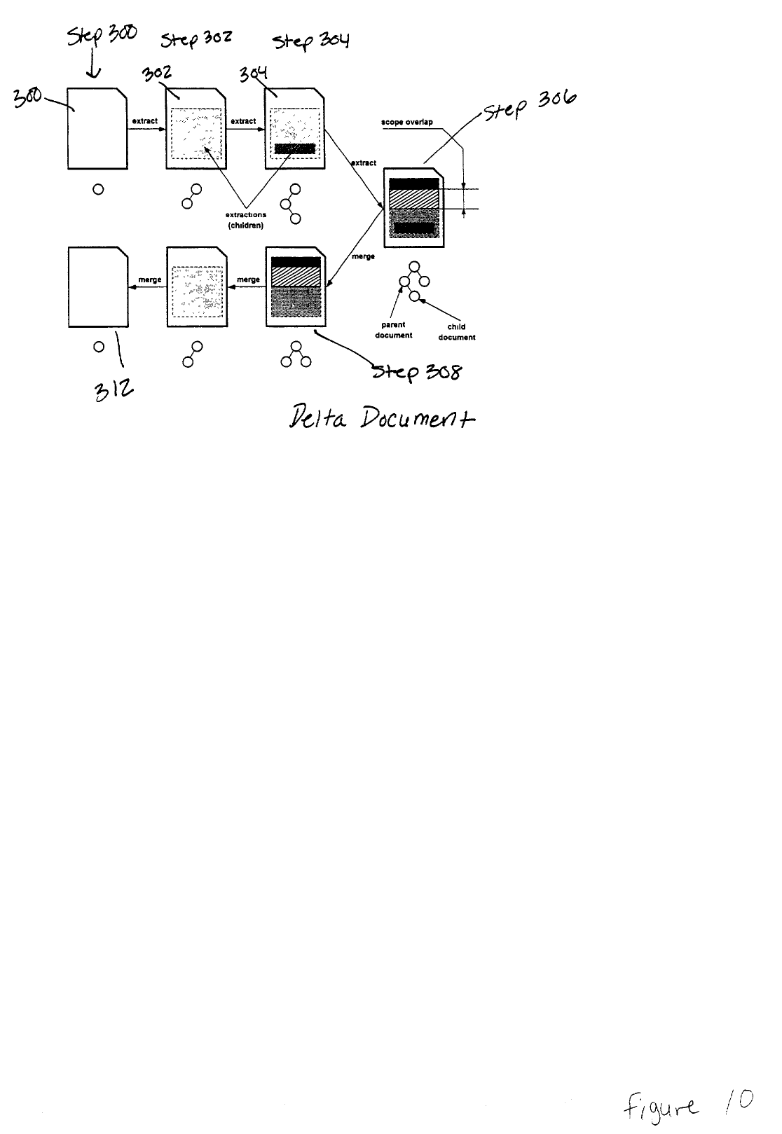

FIG. 10 illustrates the basic concepts of the δ-document and scoping strategy. Since collaborative groups co-author textual, graphical and numerical documents with multiple simultaneous modifications to each document, the present invention is designed to be application independent, having the ability to maintain multiple disparate versions of a document. This is accomplished by exploiting the inherently recursive nature of the amendment-decision cycle, and defining a set of application program interfaces (APIs) that implement a “scoping strategy”.

A δ-document is a document (parent δ-document) which may have other δ-documents as parts of it (children). The extent (content) of these δ-documents are defined by their respective scopes. To further illustrate the mechanism, consider the sequence outlined in FIG. 10 as follows:

The scope of the part of a δ-document (300) to be modified is defined (step 300);

A new child δ-document (302) is created having this scope (step 302);

A newly-created child δ-document (304) is extracted from the parent document, (step 304);

Modifications are made to the contents of the extracted child δ-document.

Modified child δ-document is merged with its parent δ-document (step 306);

Previous contents of parent δ-document in the extracted scope is discarded (or backed-up if versioning is desired) (step 308);

Contents of child δ-document is inserted into the parent δ-document according to the scope (step 312); and

The child δ-document is archived (or destroyed if no version history is required).

There may be more than one child δ-document extracted from a δ-document at any time and each extracted child δ-document may have its own children δ-documents extracted from it.

Using this scoping strategy, the concurrency control scheme of the present invention can manage simultaneous access. Participants are locked out of portions of a document which are defined as outside that particular participant's concern. This access is provided in a dynamically defined scope rather than the whole document. Locking the whole document is a special case of having a scope that spans the whole document. This facet of the present invention allows efficient and confidential sharing of documents.

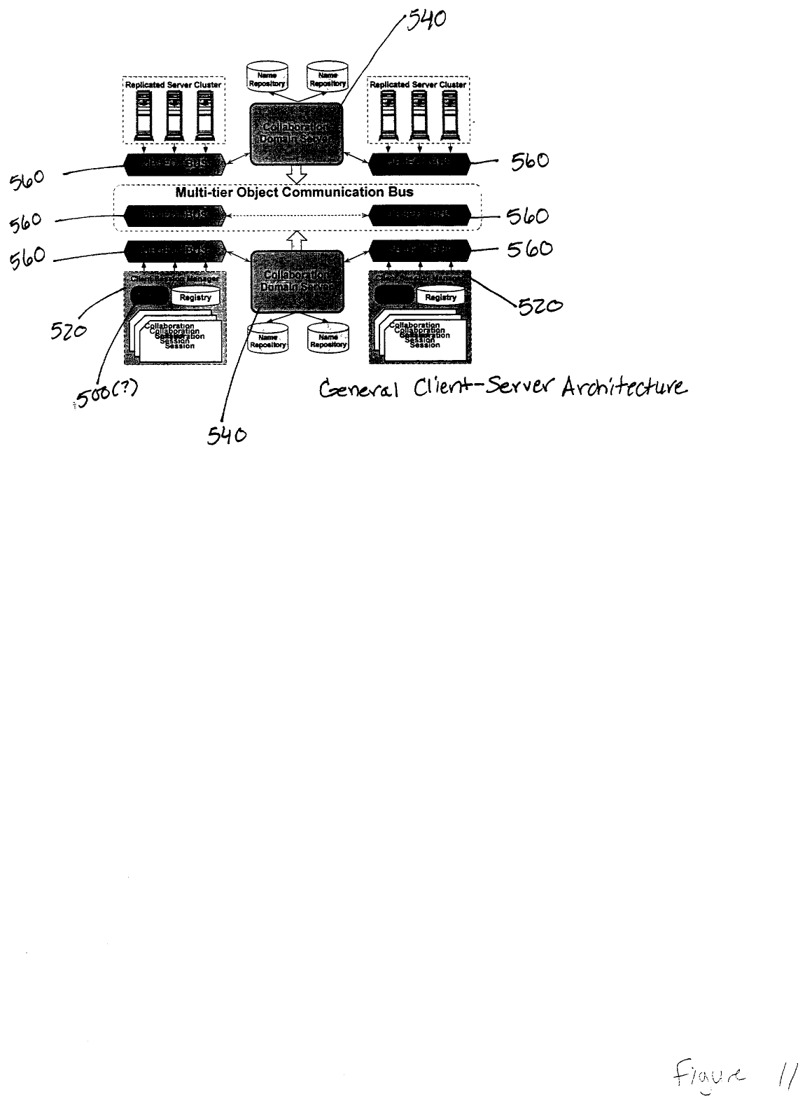

The client-server architecture of a preferred embodiment of the present invention is made up of four major components as shown in FIG. 11. The Collaboration Server (500) that maintains all system databases for each particular collaboration group, handles all client requests for data and manages all collaborative events (e.g. submission of motions, discussions, etc.), all notification services (e.g. signaling a client that a new proposal is on the table), and the general flow of the meeting (i.e. maintaining the discussion database in accordance to the extended RRO). Each collaboration group has a separate Collaboration Server (500). The Collaboration Client (520) architecture provides user access to the collaboration environment. Each collaborator comprises a Client Session Manager (522) allowing the collaborator to visualize the state of the multi-threaded discussion, tender discussion comments, make motions, access the server databases, and communicate with other members in the assembly. The Client Session Manager (522) also permits a user to participate in multiple collaboration groups simultaneously. The Collaboration Domain Server (540) serves as an active directory of collaboration groups in which a user may participate. The Collaboration Domain Server (540) functions as a repository for the names of available collaboration servers/groups. Middleware (560) specific components support interoperation among the other architectural components the database structure of a preferred embodiment of the present invention. In CORBA parlance, Middleware (560) is an ‘active data bus’ that receives object-based messages, locates the appropriate method (object-specific function), and activates the method to respond to the message. It also provides event, time and security invocation services.

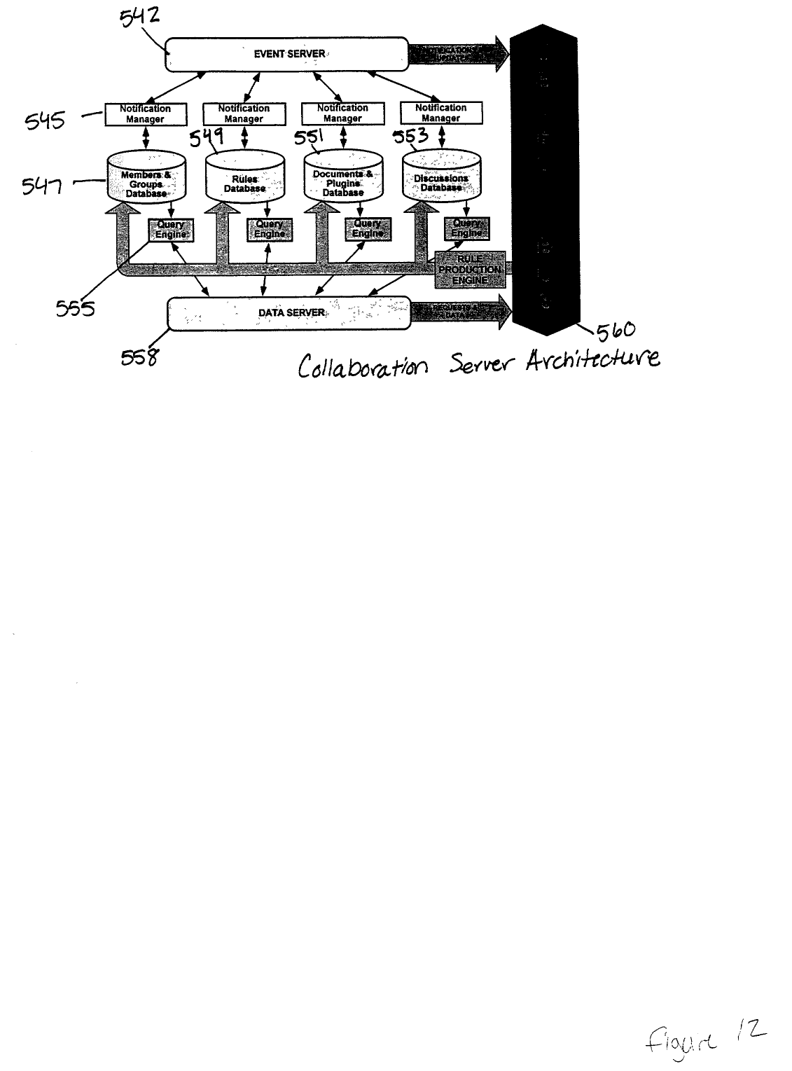

FIG. 12 illustrates the collaboration server architecture. An event server (542) accommodates notifications and updates with the assistance of the object bus (560). The event server (542) communicates with notification managers (545); each notification manager (545) is associated with a database. In a preferred embodiment, the databases associate with notification managers (545) include the following: members & groups database (547), rules database (549), documents and plug-ins database (551), and discussions database (553). These databases may be accessed through a query engine (555). A data server (558) sends data received from the query engines (555) to the object bus (560).

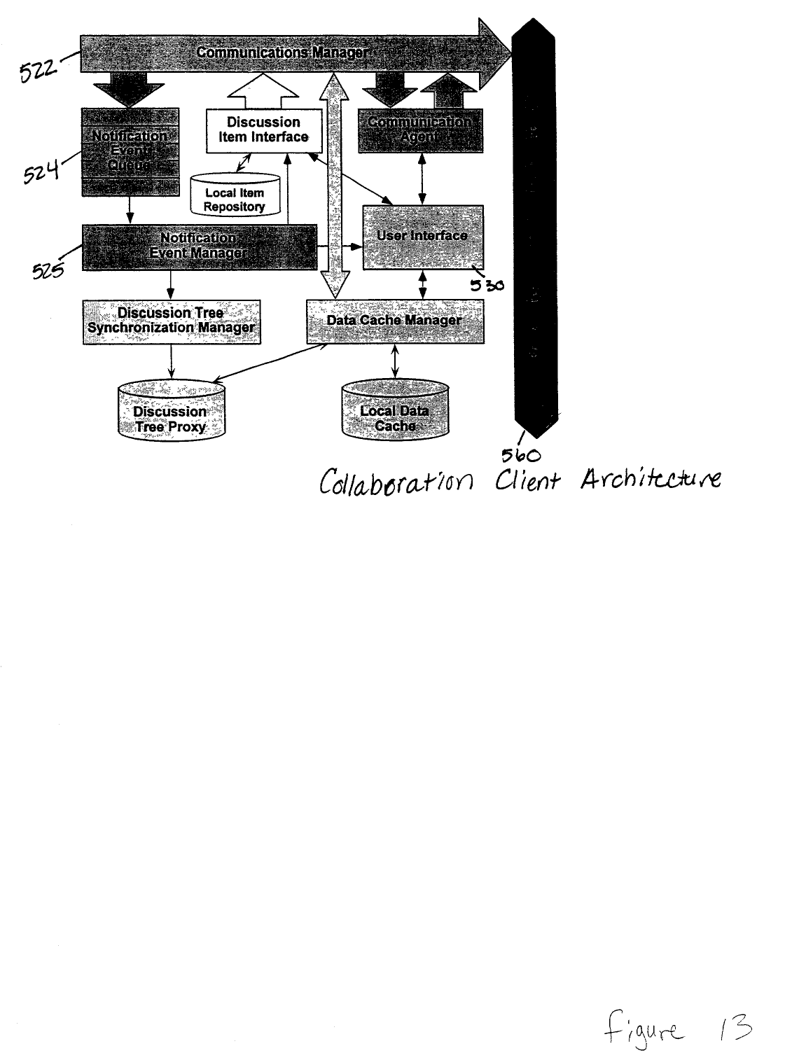

FIG. 13 illustrates the collaboration client (520) architecture. The collaboration client (520) architecture includes a communications manager (522) connected to a notification event queue (524). The notification event queue (524) is connected to the notification event manager (525). A user interface (530) is also provided.

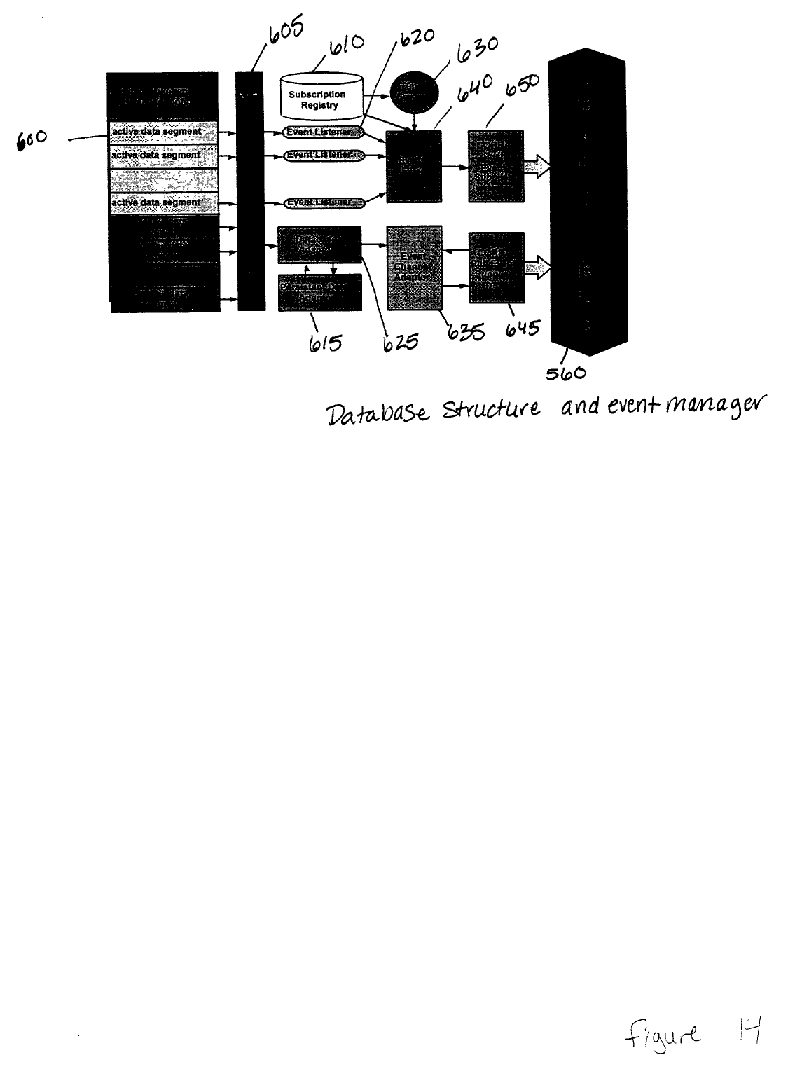

FIG. 14 illustrates the database structure and event management of a preferred embodiment of the present invention. The structure includes an active data segment (600) connected to a database API (605). Event listeners (620) are in connection with the database API (605) and an event filter (640). A subscription registry (610) is connected to a time server (630), which are both in turn connected to the event filter (640). The event filter (640) is in connection with a CORBA push event supplier (650), which is in turn in communication with the object bus (560). The database API (605) is also connected to a database adapter (625), which is in turn connected to a persistent data adapter (615) and an event channel adapter (635). The event channel adapter (635) is in communication with a CORBA pull event supplier (650), which in turn communicates with the object bus (560).

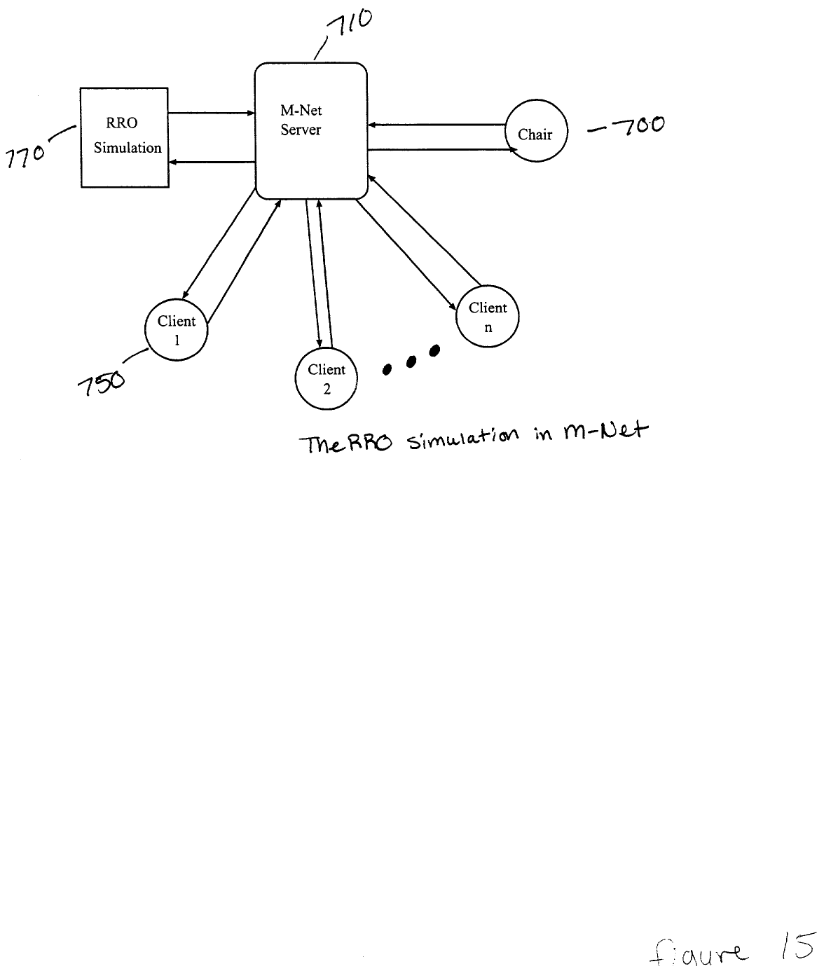

A preferred embodiment of the present invention provides a M-Net Synchronous Meeting Environment (700) as shown in FIG. 15. M-Net (700) is useful for instantaneous synchronous decision making in time-critical situations. Where all participants are simultaneously on-line, a synchronous system can maximize real-time response and reduce the lag-time inherent to asynchronous meetings. Naturally, all members must be virtually ‘present’ in a synchronous meeting, making meetings relatively more difficult to schedule. Further, since the time dimension is ‘locked’ in a synchronous meeting, all members must attend to a shared communication stream. Hence, the power of parallel activity of an asynchronous system is sacrificed. Therefore the ability to conduct both synchronous and asynchronous meetings is indispensable to create an effective collaboration environment. FIG. 15 illustrates the architecture of M-Net (700).

M-Net (700), a multimedia-based software product in preferred embodiment of the present invention, generates nested discussion threads reflecting the RRO amendment hierarchy. M-Net (700) uses a subset of the extended-RRO (770). Because synchronous meetings are typically based on a What-you-see-is-what-I-see (WYSIWIS) paradigm, floor control is important to regulate what is presented to the M-Net collaborators (750). In an M-Net (700) meeting, the M-Net Server (710) must communicate with the Collaboration Server (500) to check the validity of the scope of δ-document being proposed.

When members of an asynchronous meeting decide that a synchronous meeting is desirable, the present invention allows the scheduling of an M-Net (700) meeting using the usual proposal and discussion process. The Collaboration Server (500) will maintain the new M-Net (700) thread in its own environment but leave the M-Net (700) session alone until the M-Net (700) users arrive at resolution on the meeting issue. The M-Net (700) synchronous tools ensure the integrity of an ultimate version of checked-out material ready for check-in. For meeting information created on the fly from an M-Net (700) session, such information will be discarded upon exit from M-Net (700) and promoted to a persistent data object for archive. In this case, the Collaboration Server (500) interface must be invoked again.

Generally, most of the RRO rules adopted previously are also suitable to M-Net (700). However, since the real-time properties must be observed in M-Net (700), the extended RROs (770) are restricted and extended in that meeting coordination rules in common RRO, such as privileged motions for meeting recess, adjournment, and reconvening, must be included.

Meeting Declaration Language (MDL) (800) formally describes the meeting and related operations. Since meeting rules and constraints are context-sensitive in nature, MDL (800) must be specified as a set of context-sensitive grammar rules. Furthermore, it is unlikely that a “one-size-fits-all” approach in the RRO protocol will work across all organizational structures with varying decision making hierarchies. A common way to tailor RRO to meet these variations is to definition by-laws pertaining to quorum, decision criteria and membership.

MDL (800) is also customizable. Standard RRO which regulate physically, co-located and synchronous meetings are not compatible with the morphology of the meeting space over electronic networks. RRO rules that relate to regulation of meeting recesses, for example, may not be applicable to the distributed meeting space envisioned in the present invention. More importantly, while physical meetings cannot entertain more than one discussion channel at one time because of the limitations of the physical space, electronic meetings do not suffer such constraints.

One can, for example, participate in multiple discussions in a bulletin board simultaneously. In fact, such concurrency is one of the most attractive features of electronic collaboration. The MDL (800) handles the super subset of RRO that is most amenable to electronic collaboration. Such a super-sub-set is formalized for human collaborators.

We claim:

1. A system for providing and monitoring electronic collaboration among users comprising:
an extended parliamentary procedure rule set;
an electronic meeting environment governed by said extended parliamentary procedure rule set; and
a set of application interfaces which allow communication between said extended parliamentary procedure rule set and said electronic meeting environment.

2. A system for providing and monitoring electronic collaboration among users in claim 1 wherein said extended parliamentary procedure rule set is based on Robert's Rules of Order.

3. A system for providing and monitoring electronic collaboration among users in claim 1 wherein said electronic meeting environment allows for synchronous and asynchronous meetings.

4. A system for providing and monitoring electronic collaboration among users in claim 2 wherein said electronic meeting environment allows for synchronous and asynchronous meetings.

5. A system for providing and monitoring electronic collaboration among users in claim 1 wherein said electronic meeting environment is the Internet.

6. A system for providing and monitoring electronic collaboration among users in claim 2 wherein said electronic meeting environment is the Internet.

7. A system for providing and monitoring electronic collaboration among users in claim 3 wherein said electronic meeting environment is the Internet.

8. A system for providing and monitoring electronic collaboration among users in claim 4 wherein said electronic meeting environment is the Internet.

9. A system for providing and monitoring electronic collaboration among users in claim 1 further comprising:
a scoping policy linked to electronic meeting environment governed by said extended parliamentary procedure rule set and said set of application interfaces whereby documents may be efficiently co-authored.

10. A system for providing and monitoring electronic collaboration among users in claim 2 further comprising:
a scoping policy linked to electronic meeting environment governed by said extended parliamentary procedure rule set and said set of application interfaces whereby documents may be efficiently co-authored.

11. A system for providing and monitoring electronic collaboration among users in claim 3 further comprising:
a scoping policy linked to electronic meeting environment governed by said extended parliamentary procedure rule set and said set of application interfaces whereby documents may be efficiently co-authored.

12. A system for providing and monitoring electronic collaboration among users in claim 4 further comprising:
a scoping policy linked to electronic meeting environment governed by said extended parliamentary procedure rule set and said set of application interfaces whereby documents may be efficiently co-authored.

13. A system for providing and monitoring electronic collaboration among users in claim 5 further comprising:
a scoping policy linked to electronic meeting environment governed by said extended parliamentary procedure rule set and said set of application interfaces whereby documents may be efficiently co-authored.

14. A system for providing and monitoring electronic collaboration among users in claim 1 further comprising:
an object based client-server architecture functionally supporting said electronic meeting environment governed by said extended parliamentary procedure rule set by virtue of said set of application interfaces which allow communication between said extended parliamentary procedure rule set and said electronic meeting environment.

15. A system for providing and monitoring electronic collaboration among users in claim 2 further comprising:
an object based client-server architecture functionally supporting said electronic meeting environment governed by said extended parliamentary procedure rule set by virtue of said set of application interfaces which allow communication between said extended parliamentary procedure rule set and said electronic meeting environment.

16. A system for providing and monitoring electronic collaboration among users in claim 3 further comprising:
an object based client-server architecture functionally supporting said electronic meeting environment governed by said extended parliamentary procedure rule set by virtue of said set of application interfaces which allow communication between said extended parliamentary procedure rule set and said electronic meeting environment.

17. A system for providing and monitoring electronic collaboration among users in claim 4 further comprising:
an object based client-server architecture functionally supporting said electronic meeting environment governed by said extended parliamentary procedure rule set by virtue of said set of application interfaces which allow communication between said extended parliamentary procedure rule set and said electronic meeting environment.

18. A system for providing and monitoring electronic collaboration among users in claim 5 further comprising:
an object based client-server architecture functionally supporting said electronic meeting environment governed by said extended parliamentary procedure rule set by virtue of said set of application interfaces which allow communication between said extended parliamentary procedure rule set and said electronic meeting environment.

19. A system for providing and monitoring electronic collaboration among users comprising:
means for Internet access;
a meeting environment; and
means for allowing mitigation of a set of protocol rules within said meeting environment; and
an object based client-server architecture functionally supporting said meeting environment and said means for allowing mitigation of said set of protocol rules by virtue of said set of application interfaces which allow communication between said means for allowing mitigation of said set of protocol rules and said meeting environment.

20. A system for providing and monitoring electronic collaboration among users in claim 19 wherein said set of protocol rules is based on Robert's Rules of Order.

21. A system for providing and monitoring electronic collaboration among users in claim 19 wherein said meeting environment allows for synchronous and asynchronous meetings.

22. A system for providing and monitoring electronic collaboration among users in claim 20 wherein said meeting environment allows for synchronous and asynchronous meetings.

23. A system for providing and monitoring electronic collaboration among users in claim 20 wherein said set of protocol rules are created by a colored petri net.

24. A system for providing and monitoring electronic collaboration among users in claim 19 further comprising a means to co-author artifacts.

25. A system for providing and monitoring electronic collaboration among users in claim 20 further comprising a means to co-author artifacts.

26. A system for providing and monitoring electronic collaboration among users in claim 21 further comprising a means to co-author artifacts.

27. A system for providing and monitoring electronic collaboration among users in claim 19 wherein said object based client-server architecture comprises a collaboration server, a collaboration client, a domain server, and a set of middleware components.

28. A system for providing and monitoring electronic collaboration among users in claim 19 further comprising:
a meeting registration function;
a meeting call to order function;
a meeting list;
a meeting floor;
a means to control said meeting floor;
a means to make motions; and
an adjournment function.

29. A system for providing and monitoring electronic collaboration among users in claim 21 further comprising:
a meeting registration function;
a meeting call to order function;
a meeting list;
a meeting floor;
a means to control said meeting floor;
a means to make motions; and
an adjournment function.

30. A system for providing and monitoring electronic collaboration among users in claim 23 further comprising:
a meeting registration function;
a meeting call to order function;
a meeting list;
a meeting floor;
a means to control said meeting floor;
a means to make motions; and
an adjournment function.

31. A system for providing and monitoring electronic collaboration among users in claim 24 further comprising:
a meeting registration function;
a meeting call to order function;
a meeting list;
a meeting floor;
a means to control said meeting floor;
a means to make motions; and
an adjournment function.

32. A system for providing and monitoring electronic collaboration among users in claim 27 further comprising:
a meeting registration function;
a meeting call to order function;
a meeting list;
a meeting floor;
a means to control said meeting floor;
a means to make motions; and
an adjournment function.

33. A method for providing and monitoring electronic collaboration among users, comprising steps for:
accessing an electronic environment supported by an object based client-server architecture;
communicating through said electronic environment supported by said object based client-server architecture; and
applying a set of protocol rules within said electronic environment by virtue of said object based client-server architecture.

34. A method for providing and monitoring electronic collaboration among users in claim 33 wherein said electronic environment allows for synchronous and asynchronous communication.

35. A method for providing and monitoring electronic collaboration among users in claim 33 wherein said object based client-server architecture comprises a collaboration server, a collaboration client, a domain server, and a set of middleware components.

36. A method for providing and monitoring electronic collaboration among users in claim 34 wherein said object based client-server architecture comprises a collaboration server, a collaboration client, a domain server, and a set of middleware components.

37. A method for providing and monitoring electronic collaboration among users in claim 33 wherein said set of protocol rules is based on Robert's Rules of Order.

38. A method for providing and monitoring electronic collaboration among users in claim 37 wherein said set of protocol rules are created by a colored petri net.

39. A method for providing and monitoring electronic collaboration among users in claim 35 wherein said set of protocol rules is based on Robert's Rules of Order.

40. A method for providing and monitoring electronic collaboration among users in claim 39 wherein said set of protocol rules are created by a colored petri net.

41. A method for providing and monitoring electronic collaboration among users in claim 33 further comprising:
a meeting registration function;
a meeting call to order function;
a meeting list;
a meeting floor;
a means to control said meeting floor;
a means to make motions; and
an adjournment function.

42. A method for providing and monitoring electronic collaboration among users in claim 34 further comprising:
a meeting registration function;
a meeting call to order function;
a meeting list;
a meeting floor;
a means to control said meeting floor;
a means to make motions; and
an adjournment function.

43. A method for providing and monitoring electronic collaboration among users in claim 35 further comprising:
a meeting registration function;
a meeting call to order function;
a meeting list;
a meeting floor;
a means to control said meeting floor;
a means to make motions; and
an adjournment function.

44. A method for providing and monitoring electronic collaboration among users in claim 38 further comprising:
a meeting registration function;
a meeting call to order function;
a meeting list;
a meeting floor;
a means to control said meeting floor;
a means to make motions; and
an adjournment function.
